(19) United States
(12) Patent Application Publication
(10) Pub. No.: US 2022/0343653 A1
(43) Pub. Date: Oct. 27, 2022

(54) IMAGE PROCESSING DEVICE, PERSON SEARCH SYSTEM, IMAGE PROCESSING METHOD, AND NON-TRANSITORY COMPUTER READABLE MEDIUM

(71) Applicant: NEC Corporation, Minato-ku, Tokyo (JP)

(72) Inventors: Kapik LEE, Tokyo (JP); Takayuki ARAKAWA, Tokyo (JP)

(73) Assignee: NEC Corporation, Minato-ku, Tokyo (JP)

(21) Appl. No.: 17/620,793

(22) PCT Filed: Jun. 27, 2019
(86) PCT No.: PCT/JP2019/025708

§ 371 Date: Dec. 20, 2021

(51) Int. Cl. G06V 20/52; G06V 40/16

(52) U.S. Cl. CPC G06V 20/52; G06V 40/172; G06V 40/178

(57) ABSTRACT

A search starting point determination unit determines a search starting point in which there is a high presence probability of the target person at a first time based on the person information. A backward tracking unit estimates the presence probabilities of the target person at different locations at a second time before the first time based on the person information and determines an area where the presence probability is higher. A recognition unit calculates a degree of matching between the appearance information and the surveillance images in the area and determines a location at which the degree of matching is higher. A forward tracking unit tracks the candidates of the target person forward in time from the second time based on the person information and the location. A presence probability estimation unit estimates the presence probability of the target person at the first time.

### TECHNICAL FIELD

The present disclosure relates to an image processing device, person search system, image processing method and image processing program.

### BACKGROUND ART

An example of a conventional person allocation system is described in Patent literature 1. The conventional person allocation system includes a passenger registration unit and an image obtaining unit (surveillance camera) at the security check area in the airport, and a passenger management unit and a face search unit. The conventional person allocation system operates as follows.

The passenger registration unit registers the passenger's information by scanning the passenger's boarding pass and the surveillance camera obtains an image of the passenger, at the security check area. When there is a passenger who has not boarded even after the boarding time, the face search unit will look for the passenger in surveillance images of people whose face feature match the face feature of the passenger who has not boarded, and thus locate the passenger's current position.

### CITATION LIST

### Patent Literature

PL 1: WO No. 2014/148395

### SUMMARY OF INVENTION

### Technical Problem

The conventional person allocation system described in PL 1 uses the latest surveillance image which matches the target person's appearance. However, it is difficult to quickly obtain an image which matches the target person's appearance. The face or appearance of the target person may not be captured due to occlusion, illumination, head poses etc. and hence the target person may not be found even if surveillance images of all the surveillance cameras are checked. This checking would require a long computational time for processing the large number of images of all the surveillance cameras and is thus not suitable for searching for a person urgently.

The present disclosure has been made to solve the above mentioned problems and the objective thereof is to provide an image processing device, person search system, image processing method and image processing program that are capable of quickly searching for a target person.

### Solution to Problem

An aspect of the present disclosure is an image processing device for searching for a target person on the basis of surveillance image data captured by a plurality of cameras provided in an enclosed space, the image processing device including:

a person information obtaining unit configured to obtain person information including appearance information and characteristics information of the target person;

an image obtaining unit configured to obtain surveillance image data at different times;

a search starting point determination unit configured to determine a search starting point in which there is a high probability of the target person being present at a first time on the basis of the person information of the target person;

a backward tracking unit configured to estimate the presence probabilities of the target person being present at different locations at a second time before the first time on the basis of the person information and to determine an area where the presence probability of the target person is higher than a set threshold;

a recognition unit configured to calculate a degree of matching between the obtained appearance information of the target person and the surveillance images in the area determined by the backward tracking unit and to determine a location at which the degree of matching is higher than a set threshold;

a forward tracking unit configured to track the candidates of the target person which has the degree of matching greater than the set threshold forward in time from the second time on the basis of the person information and the location determined by the recognition unit; and

a presence probability estimation unit configured to estimate the presence probability of the target person being present at the first time or a time closer to the first time than the second time on the basis of the results of the forward tracking.

An aspect of the present disclosure is an image processing method for searching for a target person on the basis of surveillance image data captured by a plurality of cameras provided in an enclosed space, the method including:

obtaining person information including appearance information and characteristics information of the target person;

obtaining surveillance image data at different times;

determining a search starting point in which there is a high probability of the target person being present at a first time on the basis of the person information of the target person;

estimating the presence probabilities of the target person being present at different locations at a second time before the first time on the basis of the person information and determining an area where the presence probability of the target person is higher than a set threshold;

calculating a degree of matching between the obtained appearance information of the target person and the surveillance images in the determined area and determining a location at which the degree of matching is higher than a set threshold;

tracking the candidates of the target person which has the degree of matching greater than the set threshold forward in time from the second time on the basis of the person information and the location determined by the recognition unit; and

estimating a presence probability of the target person being present at the first time or a time closer to the first time than the second time on the basis of the results of the forward tracking.

An aspect of the present disclosure is an non-transitory computer readable medium storing a program for causing a computer to execute an image processing method for searching for a target person on the basis of surveillance image data captured by a plurality of cameras provided in an enclosed space, the image processing method including;

obtaining person information including appearance information and characteristics information of the target person;

obtaining surveillance image data at different times;

determining a search starting point in which there is a high probability of the target person being present at a first time on the basis of the person information of the target person;

estimating the presence probabilities of the target person being present at different locations at a second time before the first time on the basis of the person information and determining an area where the presence probability of the target person is higher than a set threshold;

calculating a degree of matching between the obtained appearance information of the target person and the surveillance images in the determined area and determining a location at which the matching score is higher than a set threshold;

tracking the candidates of the target person whose matching degree is greater than the set threshold forward in time from the second time on the basis of the person information and the location determined by the recognition unit; and

estimating a presence probability of the target person being present at the first time or a time closer to the first time than the second time on the basis of the results of the forward tracking.

### Advantageous Effects of Invention

According to the present disclosure, it is possible to provide an image processing device, person search system, image processing method and image processing program that are capable of quickly searching for a target person.

### BRIEF DESCRIPTION OF DRAWINGS

FIG. 1 is a block diagram illustrating a representative example of the structure of a first embodiment of the present disclosure;

FIG. 2 is a block diagram illustrating the structure of a second embodiment of the present disclosure;

FIG. 3 is a flow diagram illustrating the flow of the operation of the first embodiment;

FIG. 4 is a block diagram illustrating the structure of a third embodiment of the present invention;

FIG. 5 is a flow diagram illustrating the flow of the operation of the second embodiment; and

FIG. 6 is a block diagram illustrating the structure of a fourth embodiment of the present disclosure.

### DESCRIPTION OF EMBODIMENTS

Hereinafter, exemplary embodiments of the present disclosure are explained in detail with reference to the drawings. The same components are denoted by the same symbols throughout the drawings, and duplicated explanations are omitted as necessary for clarifying the explanation.

### First Embodiment

Explanation of Structure

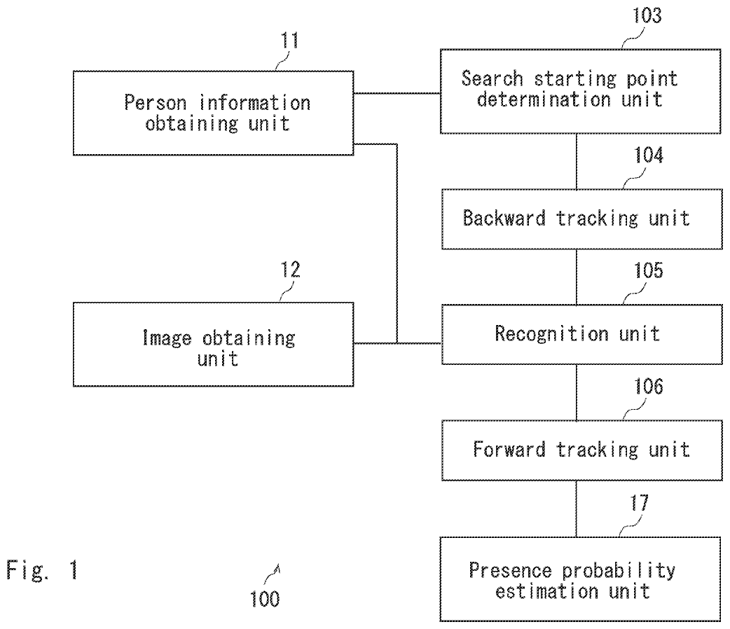

With reference to FIG. 1, a representative example of the structure of an image processing device according the present disclosure will be described.

As shown in FIG. 1, an image processing device 100 is used to search for a person in an enclosed space such as airports and amusement parks. The image processing device 100 may include a person information obtaining unit 11, an image obtaining unit 12, a search starting point determination unit 103, a backward tracking unit 104, a recognition unit 105, and a forward tracking unit 106. The person information obtaining unit 11 obtains person information including the appearance information and characteristics information of the target person. The appearance information may include clothing, hair style, height, and a face image. The characteristics information may include age, gender and nationality. The person information obtaining unit 11 may obtain such appearance information from a camera installed at a check-in counter in the airport using some image recognition techniques (e.g., biometrics, optical character recognition, iris recognition, face recognition, etc.). Also, the person information obtaining unit 11 may obtain such characteristics information from an identification information reader (e.g. a passport reader) at the check-in counter. Note that the camera and identification information reader may be installed at other preferred places in other facilities.

The image obtaining unit 102 obtains surveillance image data at different times. The image obtaining unit 102 may obtain surveillance image data via a network from a plurality of surveillance cameras provided in the enclosed space. The surveillance cameras may be installed at various positions such as boarding gates, tax-free shops, lounges, etc., in the airport to capture images of people (including a target person). Note that the surveillance cameras may be installed at various positions in harbor facilities, amusement facilities, shopping centers, stadiums or the like.

The search starting point determination unit 103 determines a search starting point in which there is a high probability of the target person being present at a first time (e.g. the current time or future time such as a boarding time). The search starting point determination unit 103 may determine a plurality of search starting points on the basis of the person information of the target person, and statistics of other people who have characteristics (e.g. age, gender and nationality) similar to those of the target person. The search starting point is merely a provisional point for starting the search and allocating the target person. Even if there are no surveillance cameras around the search starting points or the target person cannot be captured by the cameras due to occlusion, illumination, head poses etc., the image processing device 100 according to the present disclosure can track the target person using backward and forward tracking (as described below).

The backward tracking unit 104 tracks the target person backward in time from the search starting point and estimates the presence probabilities of the target person being present at different locations at a second time before the first time on the basis of the person information (e.g. walking speed of people at the same age) of the target person.

Preferably, the backward tracking unit 104 may estimate the presence probabilities of the target person being present at different locations at a plurality of times before the current time. The backward tracking unit 104 then determines an area where the presence probability of the target person is higher than a set threshold. The area may be a plurality of areas spaced from each other. According to the backward tracking unit 104, the areas where there is a high probability of the target person being present can be estimated without assuming the person only moves in one direction.

According to the backward tracking unit 104, the areas where there is a high probability of the target person being present can be estimated, so that one can check only the surveillance cameras in these areas for recognizing the target person instead of checking all the surveillance camera images, thus saving computational resources.

The recognition unit 105 calculates a degree of matching between the obtained appearance information of the target person and a surveillance image captured in the area determined by the backward tracking unit 104. The recognition unit 105 then determines a location at which the degree of matching is higher than a set threshold. The recognition unit 105 can calculate a degree of matching using not only face recognition, but also general appearance (including clothes, and hair styles) and thus identify a location where there is a high probability of the target person being present. Hence, it is not affected by temporary occlusion or changes in appearance (e.g. clothes, hair style). For example, the surveillance image of the target person recognized by the recognition unit 105 may indicate the walking direction of the target person. The surveillance image of the target person recognized by the recognition unit 105 may indicate the target person sitting on the bench.

Preferably, the recognition unit 105 may calculate a plurality of degrees of matching between the obtained appearance information of the target person and a plurality of surveillance images (at least two surveillance images) captured at different locations in the area. The recognition unit 105 may determine a plurality of locations in the area at which the degree of matching is higher than a set threshold, using a plurality of surveillance images which correspond to the different locations at the plurality of times before the current time in the area determined by the recognition unit 105. Accordingly, the recognition unit 105 can recognize how the target person tends to move, that is, the walking speed and the walking direction, etc. of the target person using not only the latest image, but also the plurality of surveillance images before the current time.

The forward tracking unit 106 statistically tracks the target person forward in time from the second time on the basis of the location determined by the recognition unit and the person information (e.g. the average walking speed of people of the same age and gender) of the target person. The forward tracking unit 106 tracks some candidates of the target person which matching degree is greater than the set threshold. The forward tracking unit 106 may estimate the current location of the target person on the basis of the walking direction of the target person recognized by the recognition unit 105. Also, the forward tracking unit 106 may estimate that the current location of the target person is not so far from the target person's location recognized by the recognition unit by considering the image in which the target person sat on the bench. The forward tracking unit 106 may estimate the locations determined by the recognition unit 105 in time forward until the time closest to the current time. The forward tracking unit 106 performs the forward tracking on the basis of the result of the recognition unit 105 to search for the target person at the present time.

The presence probability estimation unit 17 statistically estimates a presence probability of the target person who would be present at the first time or a time closer to the first time than the second time on the basis of the result of the forward tracking.

Here, definitions of the backward tracking and forward tracking will be given. The backward tracking refers to tracking the target person backward in time towards the past. The forward tracking refers to tracking the target person forward in time towards the current time or the future.

The backward tracking unit 104 collaborates with the recognition unit 105 to identify the locations where there is a high probability of the target person being present using the surveillance images. That is, the locations where there is a high probability of the target person being present before the time the latest surveillance image was photographed can be identified. The locations where there is a high probability of the target person being present after the time the latest surveillance image was photographed cannot be identified. Accordingly, the forward tracking unit 106 statistically estimates the location of the target person forward in time towards the current time or the future. Therefore, the presence probability estimation unit 17 may estimate a presence probability of the target person being present at a time closer to the first time than the second time (e.g. a time after the time the latest surveillance image was photographed).

As described above, the image processing device 100 according to the present disclosure can easily search for the target person without requiring a long computational time for processing the large number of images of all the surveillance cameras.

### Second Embodiment

Explanation of Structure

First, a second embodiment of the invention is described below referring to the accompanying drawings.

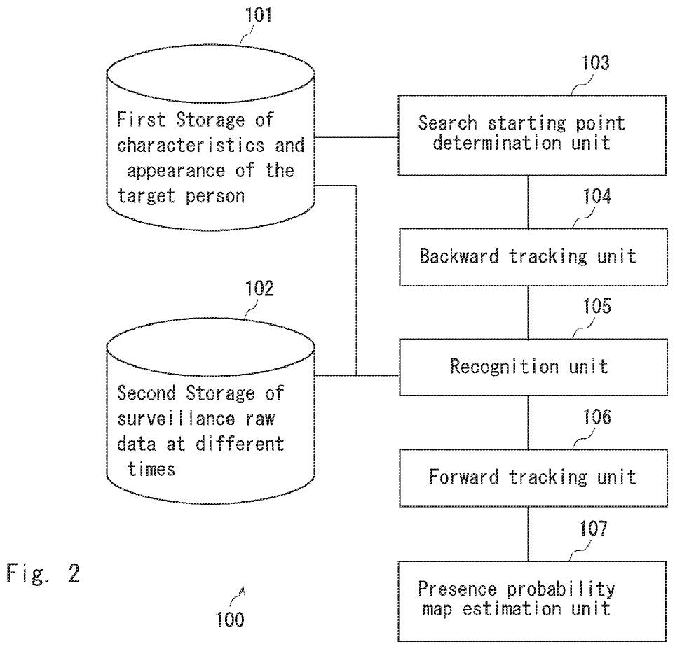

Referring to FIG. 2, an image processing device 100 according to the first embodiment includes a first storage unit 101 configured to store characteristics and appearance of the target person, a second storage unit 102 configured to store surveillance raw data at different times, a search starting point determination unit 103, a backward tracking unit 104, a recognition unit 105, a forward tracking unit 106 and a presence probability map estimation unit 107. Note that the first storage unit 101 and the second storage unit 102 may be provided inside the image processing device 100 or outside the image processing device 100. When the first storage unit 101 and the second storage unit 102 are provided outside the image processing device 100, the image processing device 100 includes the person information obtaining unit 11 and the image obtaining unit 12, as described above, which are connected to the first storage unit 101 and the second storage unit 102 via networks, respectively.

These units generally rate as follows, assuming their application is to look for a passenger (target person) who has not yet boarded (which may be referred to as a not-yet boarded passenger) at the boarding time in an airport.

The first storage unit 101 stores person information including the appearance information of the target person such as clothing, hair style, height, and face image, and characteristics information such as age, gender and nationality. The information may be stored by a camera and a reception terminal when the target person checks in at the check-in counter in the airport. The camera installed at the check-in counter can recognize the appearance information of the target person. The reception terminal can read the characteristics information from the passport of the target person.

The second storage unit 102 stores the surveillance raw data captured by all the surveillance cameras installed in the airport at different times.

The search starting point determination unit 103 determines the starting point of searching for the target person, which is a point where there is a high probability of the target person being present at the current time (or future time such as the boarding time), at which time the target person has not yet boarded and the target person's location is unknown. The determination is based on the information of the target person stored in the first storage unit 101, and statistics of other people who have characteristics (age, gender and nationality, etc.) similar to those of the target person. The search starting point determination unit 103 can determine a plurality of search starting points where there is a high probability of the target person being present at the current time.

The backward tracking unit 104 estimates the probable locations of the target person being present at some time before the current time (or the boarding time), based on the search starting point determined by the search starting point determination unit 103, the average walking speed of the target person (based on the walking speed of people of the same age) and the probability of the target person walking from different directions to the search starting point (based on statistics).

The recognition unit 105 carries out face and appearance (e.g. clothing, etc.) matching between surveillance images (obtained from the second storage unit 102) in the areas where there is a high probability of the target person being present and the face and appearance images of the target person registered during check-in. In particular, the recognition unit 105 calculates degrees of matching between the surveillance images and the face and appearance images of the target person. The recognition unit 105 can identify a plurality of locations in the area at which the matching score is higher than a set threshold.

The forward tracking unit 106 tracks the target person's location in forward time until the time closest to the current time after the time of the image photographed in which the target person is matched (a matching score is higher than a set threshold) because the target person cannot be tracked anymore in the surveillance image.

The presence probability map estimation unit 107 outputs a map indicating the presence probability of the target person at the current time (or the boarding time) according to the results of the forward tracking unit 106. These units mutually operate in such a way that the present disclosure can estimate the area in which the probability of the target person being present is high at the current time (or the boarding time).

Description of Operation

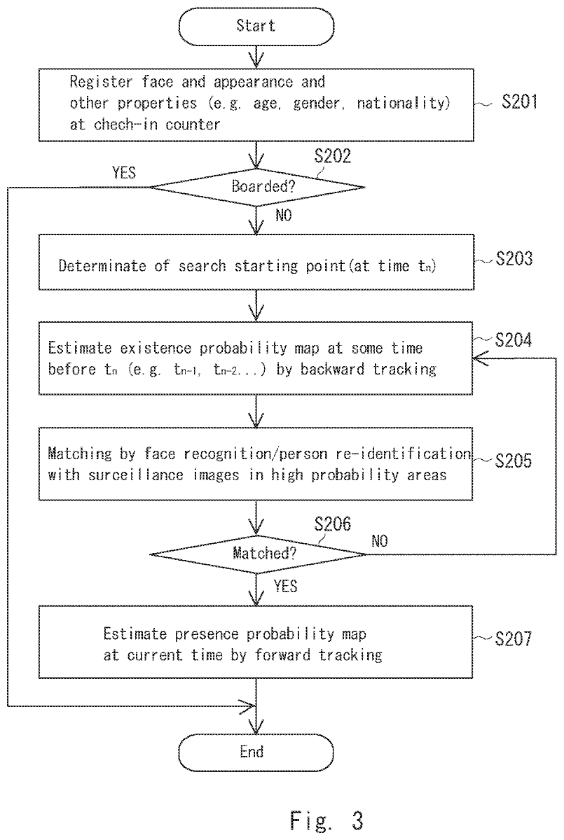

Next, referring to flowcharts in FIGS. 2 and 3, the general operation of the present embodiment will be described.

First, a passenger registers his/her face and appearance (e.g. hair style, clothing) and other characteristics (e.g. age, gender, nationality) at the check-in counter (step S201 in FIG. 3). Then in the case where the passenger has not yet boarded at the boarding time (NO in step S202), the image processing device (may be referred to as a person allocation system) 100 starts to allocate the target person (the passenger) by first determining the starting point of search for the target person at the current time tₙ (step S203).

After the starting point of searching for the target person at the current time tₙ is determined (step S203), the presence probability of the target person being present at some time before (tₙ₋₁, tₙ₋₂, . . . ) is estimated by backward tracking (step S204), based on the walking speed of the target person (estimated from average walking speed of people of the same age) and the probability of the target person coming from different directions heading to the starting point of search (based on statistics of other people with similar characteristics).

$$\begin{matrix}( math 1 ) & \\ f ( {p}_{n - 1} , {t}_{n - 1} ) = \frac{( {t}_{n} - {t}_{n - 1} ) \times v}{D ( {p}_{n} , {p}_{n - 1} )} \times M ( {p}_{n - 1} \to {p}_{n} ) & ( 1 )\end{matrix}$$

where f(p,t) is the probability of being at location p at time=t,

tₙ is the current time,

tₙ₋₁ is some time before the current time tₙ,

pₙ is the starting point of search (assumed current location),

pₙ₋₁ is any location in the airport,

v is the average walking speed of people of the same age as that of the target person,

D(pₙ,pₙ₋₁) is the distance between locations pₙ₋₁ and pₙ,

M(pₙ₋₁→pₙ) is the probability of moving from location pₙ₋₁ to pₙ, based on statistics of other people.

When the areas in which the target person is probably present are obtained, matching of faces or appearances in the images obtained from surveillance cameras in these high probability areas is carried out (step S205). The presence probability map estimation and the matching (S204 and S205) are repeatedly carried out until there is a matched surveillance images (in the case of NO in step S206). Once some surveillance images are matched (with a certain probability) at time t (YES in step S206), the presence probability of the target person being present at different locations at the current time (or some time closest to the current time) is estimated by forward tracking (step S207).

### Description of Effect

Next, the effect of the present embodiment is described.

The present embodiment is configured in such a manner that both backward and forward tracking are used, so that it is possible to estimate the target person's location even if the assumption that the target person only moves in one direction is not made.

In addition, the embodiment is configured in such a manner that the target person's location is estimated using surveillance images at different times, instead of only an image at the current time (or the boarding time), so that the matching between surveillance images and the registered face/appearance images is not affected by temporary occlusion, change of illumination, etc.

The embodiment is configured in such a manner that only the surveillance images in areas where there is a high probability of the presence of the target person are matched with the registered images. This saves computational time and resources.

### Third Embodiment

Explanation of Structure

Next, a third embodiment of the present disclosure is described referring to the accompanying drawings.

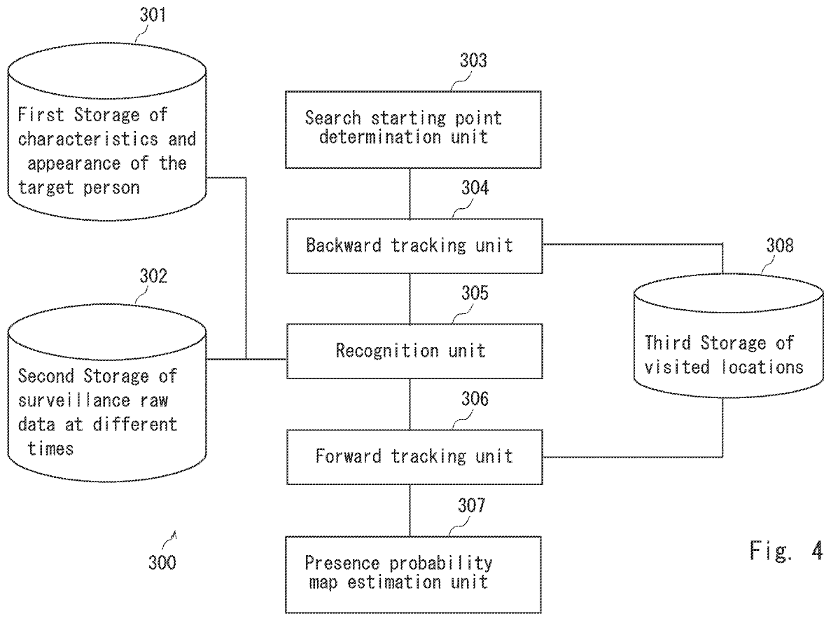

Referring to FIG. 4, similar to FIG. 2, an image processing device according to the third embodiment of the present disclosure also includes a storage of characteristics and appearance of the target person unit 301, storage of surveillance raw data at different times unit 302, search starting point determination unit 303, backward tracking unit 304, recognition unit 305, forward tracking unit 306, presence probability map estimation unit 307 and third storage unit 308.

Descriptions of units 301, 302, 303, 304, 305, 306 and 307 are similar to those of units 101, 102, 103, 104, 105, 106 and 107 in FIG. 2, hence the descriptions of these units will be omitted.

The third storage unit 308 stores the locations for which there is a high possibility that the target person has visited according to the results of forward tracking. By using the information of the visited location, the backward tracking unit 304 can carry out the backward tracking. And then the forward tracking unit 306 can carry out the forward tracking again by assuming it would be unlikely for the target person to visit particular locations more than once (e.g. security check area, shops, restaurants, etc.), for higher accuracy of the presence probability map. Preferably, both the backward tracking unit 304 and the forward tracking unit 306 use the information of the visited location. Note that the third storage unit 308 may be outside the image processing device 300. The image processing device 300 may include a visited locations obtaining unit connected to the third storage unit 308 via network.

### Description of Operation

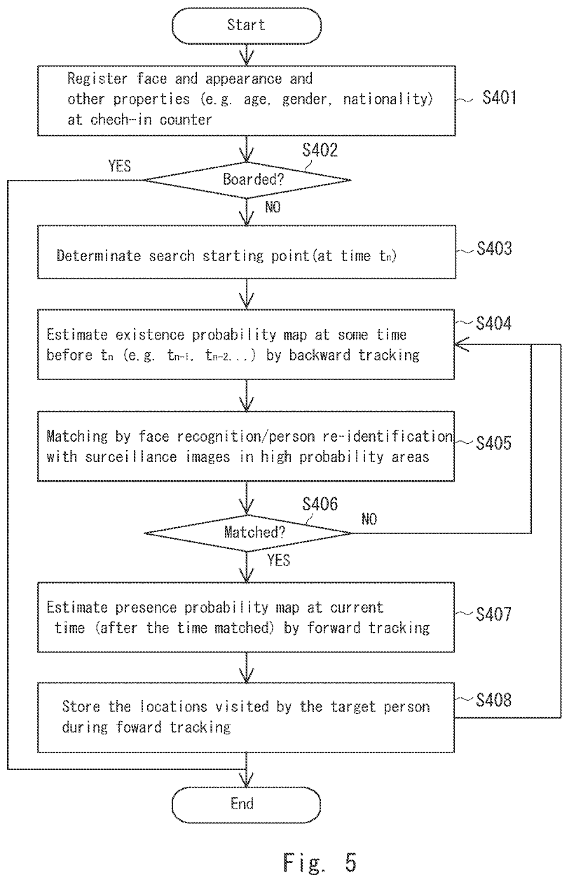

Next, referring to a flowchart in FIG. 5, the general operation of the third embodiment of the present embodiment is described. Steps S401, S402, S403, S404, S405, S406 and S407 are similar to steps S201, S202, S203, S204, S205, S206 and S207 in the FIG. 3, respectively, hence the descriptions of these steps will be omitted.

After step S407 in which the presence probability map of the target person is estimated by forward tracking, the locations visited by the target person during forward tracking are stored and fed back to the backward tracking unit 304 in FIG. 4. By assuming that the target person is unlikely to visit some particular locations more than once (e.g. security check area, restaurants, shops, etc.), backward tracking (step S404), matching (step S405) and forward tracking (step S407) can be carried out again for high accuracy of the presence probability map output at step S408.

### Description of Effect

Next, the effect of the present embodiment is described.

The description of effects which are the same as those of the first example of embodiment will be omitted here.

As the locations visited by the target person during the forward tracking are stored in the third storage unit 308 and fed back to the backward tracking again, assuming one is unlikely to visit some particular locations more than once (e.g. security check area, restaurants, shops, lounge, etc.), the M(pₙ₋₁→pₙ) term in Eq. (1) can be modified to exclude the locations which are visited during the forward tracking, hence the probability term of moving from a particular location (M(pₙ₋₁→pₙ)) to the current location in backward tracking can be modified. By excluding the locations in which the target person is not likely to be present, the backward tracking and hence the forward tracking can be more accurate.

### EXAMPLE

Next, the operation of a mode for carrying out the present disclosure is described by way of a concrete example.

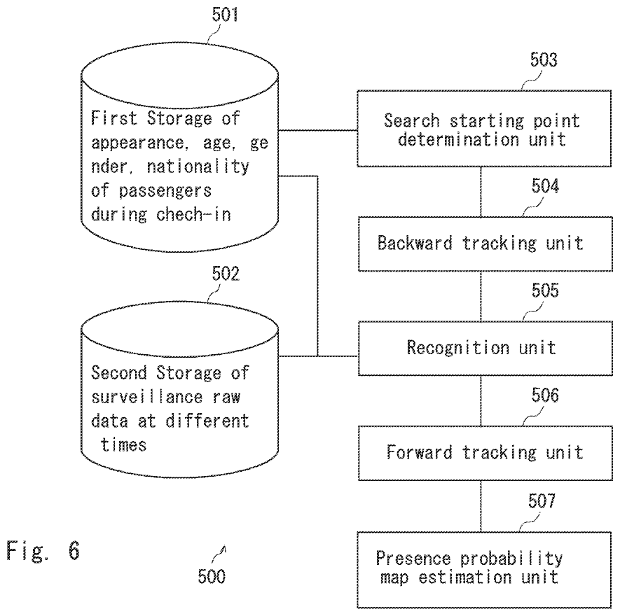

As illustrated in FIG. 6, the appearance, age, gender, nationality, etc. of passengers are registered during check-in by first storage unit 501. In the case where the passenger has not yet boarded even after the boarding time has passed, and cannot be located by a manual search, the system will estimate the probabilities of the target person being in certain areas and hence help the staff to locate the passenger in a shorter time with less man power.

Firstly, search starting point determination unit 503 will determine the starting point of search based on the statistics of other passengers of the same gender, age and nationality, etc. as those of the passenger. For example, candidates for staring point of search may be boarding gate, entrance of washrooms, shops, restaurants, lounges, etc. By assuming the passenger is present at these locations at current time tₙ, the probable locations of the passenger at some time before the current time (tₙ₋₁) are estimated by Backward tracking unit 504, based on the average walking speed of people at the same age as that of the passenger and the probability of coming from different locations at time tₙ₋₁ to the current probable locations at time tₙ.

At locations (at time tᵢ before the current time tₙ) having a certain probability that the passenger is likely to be present, matching (face recognition, appearance recognition) is carried out by Recognition unit 505. From locations with recognition scores higher than a certain threshold (which indicates that the passenger or other people with a similar appearance are likely to be present), forward tracking is carried out by forward tracking unit 506. By forward tracking from some time t, towards the current time tₙ, the presence probability map of the passenger at current time tₙ is estimated by the presence probability map estimation unit 507.

In the aforementioned embodiments, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magnetooptical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been described above with reference to exemplary embodiments, the present disclosure is not limited to the above exemplary embodiments. The configuration and details of the present disclosure can be modified in various ways which can be understood by those skilled in the art within the scope of the invention.

Although the above description has focused on estimating the target person's location at the current time, it should be appreciated that the image processing device may be used for estimating the target person's location at a future time (e.g. the boarding time). Thus, the image processing device can predict whether the target person will get to the boarding gate at the boarding time.

Some of or all the foregoing embodiments can be described as in the following appendixes, but the present invention is not limited thereto.

(Supplementary Note 1)

An image processing device for searching for a target person on the basis of surveillance image data captured by a plurality of cameras provided in an enclosed space, comprising:

a person information obtaining unit configured to obtain person information including appearance information and characteristics information of the target person;

an image obtaining unit configured to obtain surveillance image data at different times;

a search starting point determination unit configured to determine a search starting point in which there is a high probability of the target person being present at a first time on the basis of the person information of the target person;

a backward tracking unit configured to estimate the presence probabilities of the target person being present at different locations at a second time before the first time on the basis of the person information and to determine an area where the presence probability of the target person is higher than a set threshold;

a recognition unit configured to calculate a degree of matching between the obtained appearance information of the target person and the surveillance images in the area determined by the backward tracking unit and to determine a location at which the degree of matching is higher than a set threshold;

a forward tracking unit configured to track the candidates of the target person whose matching degree is greater than the set threshold forward in time from the second time on the basis of the person information and the location determined by the recognition unit; and

a presence probability estimation unit configured to estimate the presence probability of the target person being present at the first time or a time closer to the first time than the second time on the basis of the results of the forward tracking.

(Supplementary Note 2)

The image processing device according to Note 1, wherein

the backward tracking unit is configured to estimate the probability of the target person being present at different locations at the second time before the first time on the basis of the probability of the target person moving to the search starting point from other locations.

(Supplementary Note 3)

The image processing device according to Note 1 or 2, further comprising:

a visited locations obtaining unit configured to obtain visited locations information on locations visited by the target person, and

wherein the forward tracking unit is configured to estimate probability of a location being visited by the target person using the visited locations information.

(Supplementary Note 4)

The image processing device according to Note 3, wherein

the backward tracking unit is configured to obtain the location estimated by the forward tracking unit as the visited locations information and to perform backward tracking on the basis of the visited locations information.

(Supplementary Note 5)

The image processing device according to any one of Note 1 to Note 4, wherein

the presence probability estimation unit is configured to output a map indicating the presence probabilities of the target person being present at different locations.

(Supplementary Note 6)

The image processing device according to any one of Note 1 to Note 5, wherein the appearance information includes clothing, hair style, height, and face image.

(Supplementary Note 7)

The image processing device according to any one of Note 1 to Note 6, wherein the characteristics information includes age, gender and nationality.

(Supplementary Note 8)

A person search system comprising:

the image processing device according to any one of Note 1 to Note 7; and

a plurality of surveillance cameras provided in an enclosed space.

(Supplementary Note 9)

A person search system according to Note 8 further comprising:

a first storage unit configured to store person information including the appearance information and characteristics information of the target person; and

a second storage unit configured to store the surveillance raw data at different times.

(Supplementary Note 10)

An image processing method for searching for a target person on the basis of surveillance image data captured by a plurality of cameras provided in an enclosed space, the method comprising:

obtaining person information including appearance information and characteristics information of the target person;

obtaining surveillance image data at different times;

determining a search starting point in which there is a high probability of the target person being present at a first time on the basis of the person information of the target person;

estimating the presence probabilities of the target person being present at different locations at a second time before the first time on the basis of the person information and determining an area where the presence probability of the target person is higher than a set threshold;

calculating a degree of matching between the obtained appearance information of the target person and the surveillance images in the determined area and determining a location at which the degree of matching is higher than a set threshold;

tracking the candidates of the target person whose matching degree is greater than the set threshold forward in time from the second time on the basis of the person information and the location determined by the recognition unit; and

estimating a presence probability of the target person being present at the first time or a time closer to the first time than the second time on the basis of the results of the forward tracking.

(Supplementary Note 11)

A non-transitory computer readable medium storing an image processing program for causing a computer to execute an image processing method for searching for a target person on the basis of surveillance image data captured by a plurality of cameras provided in in an enclosed space, the image processing method comprising:

obtaining person information including appearance information and characteristics information of the target person;

obtaining surveillance image data at different times;

determining a search starting point in which there is a high probability of the target person being present at a first time on the basis of the person information of the target person;

estimating the presence probabilities of the target person being present at different locations at a second time before the first time on the basis of the person information and determining an area where the presence probability of the target person is higher than a set threshold;

calculating a degree of matching between the obtained appearance information of the target person and the surveillance images in the determined area and determining a location at which the matching score is higher than a set threshold;

tracking candidates of the target person whose matching degree is greater than the set threshold forward in time from the second time on the basis of the person information and the location determined by the recognition unit; and

estimating a presence probability of the target person being present at the first time or a time closer to the first time than the second time on the basis of the results of the forward tracking.

### INDUSTRIAL APPLICABILITY

The present disclosure is applicable to a search system for passengers who have not yet boarded although the boarding time has passed. The present disclosure is also applicable to a search system for looking for children who have got separated from their parents in amusement parks or in shopping malls.

### REFERENCE SIGNS LIST

11 Person Information Obtaining Unit
12 Image Obtaining Unit
17 Presence probability estimation unit
100 Image processing device
101 First Storage unit
102 Second Storage unit
103 Search starting point determination unit
104 Backward tracking unit
105 Recognition unit
106 Forward tracking unit
107 Presence probability map estimation unit
300 Person Allocation System
301 First Storage unit
302 Second Storage unit
303 Search starting point determination unit
304 Backward tracking unit
305 Recognition unit
306 Forward tracking unit
307 Presence probability map estimation unit
308 Third Storage unit
500 Person Allocation System
501 First Storage unit
502 Second Storage unit
503 Search starting point determination unit
504 Backward tracking unit
505 Recognition unit
506 Forward tracking unit
507 Presence probability map estimation unit

What is claimed is:

1. An image processing device for searching for a target person on the basis of surveillance image data captured by a plurality of cameras provided in an enclosed space, comprising:
a person information obtaining unit configured to obtain person information including appearance information and characteristics information of the target person;
an image obtaining unit configured to obtain surveillance image data at different times;
a search starting point determination unit configured to determine a search starting point in which there is a high probability of the target person being present at a first time on the basis of the person information of the target person;
a backward tracking unit configured to estimate the presence probabilities of the target person being present at different locations at a second time before the first time on the basis of the person information and to determine an area where the presence probability of the target person is higher than a set threshold;
a recognition unit configured to calculate a degree of matching between the obtained appearance information of the target person and the surveillance images in the area determined by the backward tracking unit and to determine a location at which the degree of matching is higher than a set threshold;
a forward tracking unit configured to track the candidates of the target person whose matching degree is greater than the set threshold forward in time from the second time on the basis of the person information, and the location determined by the recognition unit; and
a presence probability estimation unit configured to estimate the presence probability of the target person being present at the first time or a time closer to the first time than the second time on the basis of the results of the forward tracking.

2. The image processing device according to claim 1, wherein
the backward tracking unit is configured to estimate the probability of the target person being present at different locations at the second time before the first time on the basis of the probability of the target person moving to the search starting point from other locations.

3. The image processing device according to claim 1, further comprising:
a visited locations obtaining unit configured to obtain visited locations information on locations visited by the target person, and
wherein the forward tracking unit is configured to estimate probability of a location being visited by the target person using the visited locations information.

4. The image processing device according to claim 3, wherein
the backward tracking unit is configured to obtain the location estimated by the forward tracking unit as the visited locations information and to perform backward tracking on the basis of the visited locations information.

5. The image processing device according to claim 1, wherein
the presence probability estimation unit is configured to output a map indicating the presence probabilities of the target person being present at different locations.

6. The image processing device according to claim 1, wherein the appearance information includes clothing, hair style, height, and face image.

7. The image processing device according to claim 1, wherein the characteristics information includes age, gender and nationality.

8-9. (canceled)

10. An image processing method for searching for a target person on the basis of surveillance image data captured by a plurality of cameras provided in an enclosed space, the method comprising:
obtaining person information including appearance information and characteristics information of the target person;
obtaining surveillance image data at different times;
determining a search starting point in which there is a high probability of the target person being present at a first time on the basis of the person information of the target person;
estimating the presence probabilities of the target person being present at different locations at a second time before the first time on the basis of the person information and determining an area where the presence probability of the target person is higher than a set threshold;
calculating a degree of matching between the obtained appearance information of the target person and the surveillance images in the determined area and determining a location at which the degree of matching is higher than a set threshold;
tracking the candidates of the target person whose matching degree is greater than the set threshold forward in time from the second time on the basis of the person information and the location determined by the recognition unit; and
estimating a presence probability of the target person being present at the first time or a time closer to the first time than the second time on the basis of the results of the forward tracking.

11. A non-transitory computer readable medium storing an image processing program for causing a computer to execute an image processing method for searching for a target person on the basis of surveillance image data captured by a plurality of cameras provided in in an enclosed space, the image processing method comprising:
obtaining person information including appearance information and characteristics information of the target person;
obtaining surveillance image data at different times;
determining a search starting point in which there is a high probability of the target person being present at a first time on the basis of the person information of the target person;
estimating the presence probabilities of the target person being present at different locations at a second time before the first time on the basis of the person information and determining an area where the presence probability of the target person is higher than a set threshold;
calculating a degree of matching between the obtained appearance information of the target person and the surveillance images in the determined area and determining a location at which the matching degree is higher than a set threshold;
tracking the candidates of the target person whose matching degree is greater than the set threshold forward in time from the second time on the basis of the person information and the location determined by the recognition unit; and
estimating a presence probability of the target person being present at the first time or a time closer to the first time than the second time on the basis of the results of the forward tracking.

12. The image processing method according to claim 10, wherein
the backward tracking includes estimating the probability of the target person being present at different locations at the second time before the first time on the basis of the probability of the target person moving to the search starting point from other locations.

13. The image processing method according to claim 10, further comprising:
obtaining visited locations information on locations visited by the target person, and wherein the forward tracking includes estimating probability of a location being visited by the target person using the visited locations information.

14. The image processing method according to claim 13, wherein
the backward tracking includes obtaining the location estimated by the forward tracking as the visited locations information and performing backward tracking on the basis of the visited locations information.

15. The image processing method according to claim 10, wherein
the presence probability estimation includes outputting a map indicating the presence probabilities of the target person being present at different locations.

16. The image processing method according to claim 10, wherein the appearance information includes clothing, hair style, height, and face image.

17. The image processing method according to claim 10, wherein the characteristics information includes age, gender and nationality.

18. The non-transitory computer readable medium according to claim 11, wherein the backward tracking includes estimating the probability of the target person being present at different locations at the second time before the first time on the basis of the probability of the target person moving to the search starting point from other locations.

19. The non-transitory computer readable medium according to claim 11, the image processing method further comprising:
obtaining visited locations information on locations visited by the target person, and
wherein the forward tracking includes estimating probability of a location being visited by the target person using the visited locations information.

20. The non-transitory computer readable medium according to claim 19, wherein the backward tracking includes obtaining the location estimated by the forward tracking as the visited locations information and performing backward tracking on the basis of the visited locations information.

21. The non-transitory computer readable medium according to claim 11, wherein
the presence probability estimation includes outputting a map indicating the presence probabilities of the target person being present at different locations.

22. The non-transitory computer readable medium according to claim 11, wherein the appearance information includes clothing, hair style, height, and face image.
